(19) United States
(12) Patent Application Publication
(10) Pub. No.: US 2018/0056238 A1
(43) Pub. Date: Mar. 1, 2018

(54) Simplified Air Quality Control System For Fluid Catalytic Cracking Units

(71) Applicant: General Electric Technology GmbH, Baden (CH)

(72) Inventors: Andrea Caruso, Wiesbaden (DE); Lars-Erik Johansson, Vaxjo (SE); Raymond RauIfs Gansley, Knoxville, TN (US)

(21) Appl. No.: 15/251,027

(22) Filed: Aug. 30, 2016

(51) Int. Cl. B01D 53/75; B01D 53/86; B01D 53/50; B01D 53/96

(52) U.S. Cl. CPC B01D 53/75; B01D 53/8631; B01D 53/96; B01D 53/508; B01D 53/507

(57) ABSTRACT

The present application provides an air quality control system for cleaning a flue gas from a fluid catalytic cracking unit. The air quality control system may include a selective catalytic reduction system in communication with the flue gas to remove nitrogen oxides and a wet scrubber positioned downstream of the selective catalytic reduction system and in communication with the flue gas to remove sulfur oxides and particulates.

### TECHNICAL FIELD

The present application and the resultant patent relate generally to environmental control systems and methods and more particularly relate to a simplified air quality control system for a fluid catalytic cracking unit to clean the flue gases emitted therefrom.

### BACKGROUND OF THE INVENTION

Generally described, a fluid catalytic cracking unit vaporizes and breaks long chain molecules of high boiling hydrocarbon liquids into much shorter molecules by contacting a feedstock, at high temperature and moderate pressure, with a fluidized powdered catalyst. The flue gases emitted from the fluid catalytic cracking unit may contain significant amounts of nitrogen oxides, sulfur oxides, catalyst dust, and other types of pollutants. The flue gases thus must undergo a cleansing or purification process before emission into the atmosphere. The flue gases are conventionally cleaned via a wet scrubbing technology and the like. Such a standard “long chain” approach may use electrostatic precipitators, gas-gas heaters, and other types of power consuming devices. Such flue gas cleaning technology thus may consume a significant amount of power that may minimize the overall energy recovery to the grid.

### SUMMARY OF THE INVENTION

The present application and the resultant patent thus provide an air quality control system for cleaning a flue gas from a fluid catalytic cracking unit. The air quality control system may include a selective catalytic reduction system in communication with the flue gas to remove nitrogen oxides and a wet scrubber positioned downstream of the selective catalytic reduction system and in communication with the flue gas to remove sulfur oxides and particulates.

The present application and the resultant patent further provide a method of cleaning a flue gas. The method may include the steps of removing nitrogen oxides in the flue gas in a selective catalytic reduction system, removing sulfur oxides and particulates in the flue gas in a wet scrubber, and removing sulfur trioxides in the flue gas in a sulfur trioxide removal system if the levels of sulfur trioxide in the flue gas exceed a predetermined level.

The present application and the resultant patent further provide a simplified air quality control system for cleaning a flue gas from a fluid catalytic cracking unit. The air quality control system may include a selective catalytic reduction system in communication with the flue gas to remove nitrogen oxides, a wet scrubber positioned downstream of the selective catalytic reduction system and in communication with the flue gas to remove sulfur oxides and particulates, and a sulfur trioxide removal system in communication with the flue gas to remove sulfur trioxides if the sulfur trioxides exceed a predetermined level.

These and other features and improvements of the present application and the resultant patent will become apparent to one of ordinary skill in the art upon review of the following detailed description when taken in conjunction with the provided drawing and the appended claims.

### BRIEF DESCRIPTION OF THE DRAWING

FIG. 1 is a schematic diagram of a simplified air quality control system as may be described herein for use with a fluid catalytic cracking unit or other sources of a flue gas.

### DETAILED DESCRIPTION

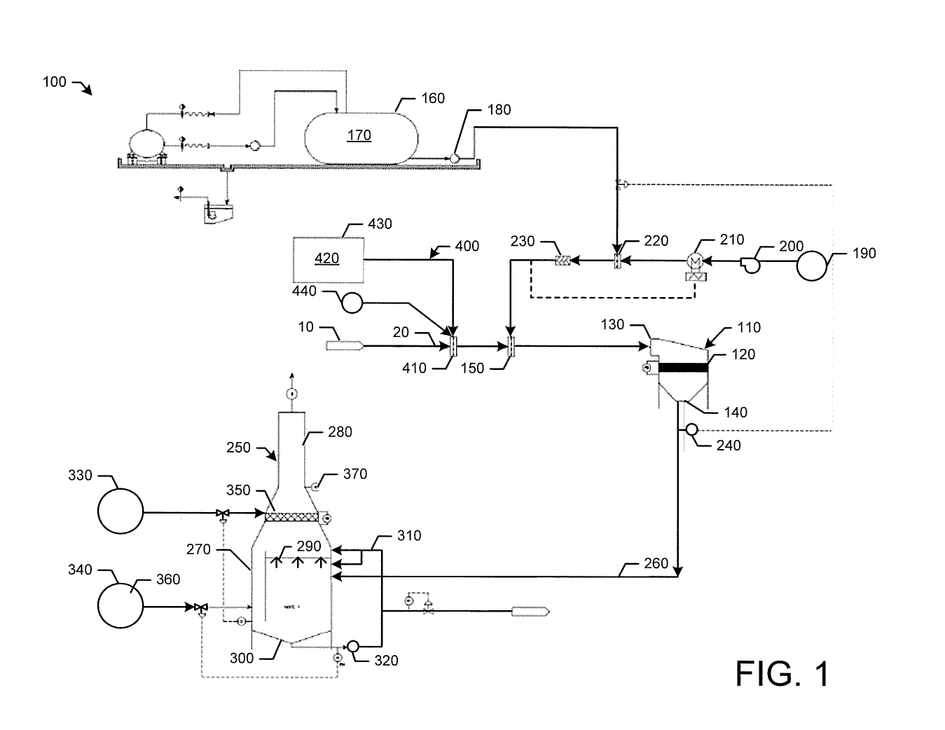

Referring now to the drawing, in which like numerals refer to like elements, FIG. 1 shows an example of an air quality control system 100 as may be described herein. The air quality control system 100 may be used with a fluid catalytic cracking unit 10. The fluid catalytic cracking unit 10 may be of conventional design. The fluid catalytic cracking unit 10 produces a flue gas 20. As described above, the flue gas 20 may include pollutants therein including nitrogen oxides, sulfur oxides, catalyst dust, and the like. Although the air quality control system 100 will be described in the context of the flue gases 20 produced by the fluid catalytic cracking unit 10, it will be understood that the air quality control system 100 may be used with any source of flue gases 20 and the like.

The simplified air quality control system 100 may include a selective catalytic reduction system 110. The selective catalytic reduction system 110 reduces the overall levels of nitrogen oxides in the stream of the flue gases 20. The selective catalytic reduction system 110 may be positioned downstream of the fluid catalytic cracking unit 10 or other source of the flue gases 20. The selective catalytic reduction system 110 includes a catalyst 120 therein so as to react with and convert the nitrogen oxides contained in the flue gases 20 into nitrogen and water. The catalyst 120 may be of conventional design and may be manufactured from suitable carrier and active catalytic components. For example, a vanadium/titanium oxides catalyst and the like may be used. Other types of catalysts and catalytic materials may be used herein. The catalyst 120 may have any suitable size, shape, or configuration. A reactor may be equipped with auxiliary systems like soot blowers and the like.

The selective catalytic reduction system 110 extends from an inlet 130 to an outlet 140 with the catalyst 120 therebetween. A reducing agent injection grid 150 is positioned upstream of the catalyst 120 and injects a reducing agent 160 into the flue gases 20. The reducing agent 160 may be an ammonia or urea liquid solution. Other types of reducing agents 160 may be used herein. The injection grid 150 may be in communication with a reducing agent source 170 via a reducing agent pump 180 and in communication with an air source 190 via an air fan 200 and an air heater 210. The flows of the reducing agent and air meet in a reducing injector 220. The injector 220 may be of conventional design. The reducing agent may be atomized using air in a static mixer 230 and the like. The static mixer 230 may be of conventional design. Other components and other configurations may be used herein.

The injector 150 thus injects an atomized and evaporated flow of the reducing agent 160 into the flow of the flue gases to the selective catalytic reduction system 110. The flue gases 20 then flow through the catalyst 120 that converts the nitrogen oxides into nitrogen and water. A nitrogen oxide analyzer 240 may be positioned at the outlet 140 to continually monitor the residual concentration of nitrogen oxides so as to provide feedback control, e.g., to adjust the reducing agent flowrate injected into the flue gases 20. Other component, configurations, and control strategies may be used herein.

The overall efficiency of the selective catalytic reduction system 110 and the possibility to operate it smoothly and to minimize down time and maintenance depend in part on the temperature of the flue gases 20 that may be adjusted based on the flue gas sulfur content. Specifically, the selective catalytic reduction system 110 may have a relatively narrow effective temperature range. The flow temperature thus may be controlled by means of a boiler, a fuel gas burner, a tempering air system, a steam heater, and the like. The temperature of the air stream to the reducing agent injector 220 likewise may be controlled via the air heater 210 or by an equivalent heating source. The selective catalytic reduction system 110 also may be bypassed in case of high dust load, high pressure/trip of the boiler, or loss of activity with respect to the catalyst 120 and the like.

The air quality control system 100 also may include a wet scrubber 250 of different types. The wet scrubber 250 is used for the removal of sulfur oxides and particulate matter such as the catalyst dust from the fluid catalytic cracking unit 10. The wet scrubber 250 may be positioned downstream of the selective catalytic reduction system 110. The length of a connecting flue gas duct 260 between the selective catalytic reduction system 110 and the wet scrubber 250 preferably may be minimized so as to ensure that the simplified air quality control system 100 as a whole has as small a footprint as possible.

Generally described, the wet scrubber 250 includes a contact vessel 270 where the flue gas is washed by exploiting the intimate contact between the flue gas and the scrubbing fluid. The wet scrubber 250 also may be equipped with a stack 280 above the contact vessel 270. The stack 280 may be stainless steel and the like so as to resist acid corrosion. The stack 280 may be detached from the contact vessel 270. The contact vessel 270 and the stack 280 may have any suitable size, shape, or configuration. According to the requested cleaning performance and the specific particulate size distribution, the wet scrubber 250 may be of different types including but not limited to spray towers, bubble bed absorbers, Venturi absorbers, multiple tray absorbers, impingement plate absorbers, packed bed absorbers, and the like. The wet scrubber 250 therefore may have different configurations including the use of a number of spray levels each of one equipped with an optimized number of spray nozzles (open spray tower) or one (or more) perforated tray 290 as shown in the attached diagram to control the liquid level on the tray (bubble bed absorber) and the like and a fluid collector 300 at the bottom. The wet scrubber 250 includes a recirculation line 310 with a recirculation pump 320 thereon. The recirculation line 310 extends from the fluid collector 300 at the bottom of the wet scrubber 250 to the spray nozzles or tray 290 at the top thereof. The wet flue gas scrubber 250 also may be in communication with a makeup water source 330 and an alkaline source 340. An alkaline reagent 360 may be highly soluble such as caustic soda. Other types of alkaline solutions may be used herein. The wet scrubber 250 is also equipped with a mist eliminator 350 and the like. Other components and other configurations may be used herein.

In use, the flue gases 20 enter the wet scrubber 250 via the connecting flue gas duct 260. The flue gases 20 enter the wet scrubber 250 and are progressively quenched, saturated, and washed, for example, by passing through the spray nozzle section or by bubbling through the liquid bed of the perforated tray 290 (bubble bed absorber). The alkaline reagent 360 is dosed in the absorber bottom to react with and enhance the sulfur oxides absorption and keep a suitable pH level. The cleaned flue gases 20 then are released to the atmosphere via the stack 280. The liquid blowdown may be continuously routed to a waste water treatment unit using a blowdown line to control the suspended and dissolved solids concentration in the wet scrubber 250. One or more emissions sensors 370 may be positioned at the stack 280 outlet so as to monitor the emissions level therein and provide feedback control.

The type of the wet scrubber 250 used herein may be based on the required particulate removal efficiency, the expected particle size distribution, and any specific pressure drop constraints. Applications featuring a favorable particle size distribution and targeting average dust emission limits may be addressed via a traditional open spray tower or similar solutions. If higher dust particle removal efficiencies are required, other types of scrubbers such as bubble bed absorber as shown above, multiple trays absorbers, Venturi absorbers, packed bed absorbers and the like may be used but at the expense of higher pressure drops. Specifically, the cleaning effect as shown above may be achieved by forcing the flue gases 20 to bubble through a liquid bed of the perforated trays 290. Scrubbers that clean the flue gas in the liquid phase result in higher dust removal efficiencies as compared to open spray towers.

Depending upon the levels of sulfur trioxides in the flue gases 20, the simplified air quality control system 100 may include a sulfur trioxide removal system 400. The sulfur trioxide removal system 400 may be positioned downstream of the fluid catalytic cracking unit 10 or other source of the flue gases 20 and upstream of the selective catalytic reduction system 110. Other positions also may be used herein. The sulfur trioxide removal system 400 may include a number of injection lances 410. The, injection lances 410 may have any suitable size, shape, or configuration. The injection lances 410 are in communication with a sulfur trioxide removal solution 420 on a sulfur trioxide removal skid 430 or other type of platform. The sulfur trioxide removal solution 420 may be prepared using caustic soda, sodium carbonate, sodium bicarbonate, and the like. Alternatively a dry injection of sodium bicarbonate, sodium sesquicarbonate (trona), or similar sorbents may be used. Other types of sorbents or solutions may be used herein.

Positioning the sulfur trioxide removal system 400 upstream of the selective catalytic reduction system 110 may allow for an adequate residence time for the sulfur trioxide removal reactions to be completed before entering the selective catalytic reduction system 110. The injection lances 410 are used to ensure a good dispersion of the sorbent or the solution so as to achieve high utilization of the reagent. For this reason, the injection lances are also in communication with an air source 440. The air source 440 may provide an adequate distribution of the sulfur trioxide removal sorbent 420 in the flow of the flue gases 20 for reaction therewith. Other components and other configurations also may be used herein.

The sulfur trioxide removal system 400 may remove at least about 95% of the sulfur trioxides and may extend the life of the downstream catalyst 120. The sulfur oxide removal system 400 also may mitigate the risk of poisoning the catalyst of the reactor associated with the simultaneous presence of ammonia (in case an ammonia solution is used as reducing agent 160 for the nitrogen oxides) and sulfur trioxide which may lead to the formation of ammonium bisulfate. Condensation of ammonium bisulfate in the pores of the catalyst 120 may cause blockage and render the catalyst inactive. Nevertheless, the ammonium bisulfate condensation is reversible by adequately increasing the operating temperature. A suitable temperature increase (regeneration temperature) will cause the ammonium bisulfate to vaporize and the catalyst activity be restored.

The amount of the sulfur trioxides in the flue gases 20 may depend on the combustion conditions and the overall sulfur content of the fuel burnt in the fluid catalytic cracking unit 10 or other source. The sulfur trioxide removal system 400 only need be used to prevent sulfur plumes at the stack and specifically when the content of the sulfur trioxides in the flue gases 20 exceeds a predetermined level. This level depends also on the specific system 100 configuration and the type of wet scrubber. For example, sulfuric plumes are generally not visible when the content of the sulfur oxides at the stack 280 do not exceed about 5 ppm (volume wet basis). Levels of sulfur trioxides below this threshold generally can be captured by the wet scrubber 250 and reduced at the stack below 5 ppm volume without the need for the sulfur trioxide removal system 400.

The simplified air quality control system 100 thus provides adequate cleaning of the flue gases 20 with either high or low sulfur oxide content, high or low nitrogen oxide content, and/or high or low dust loading (high load shall be intended within the typical fluid catalytic cracking unit dust envelope) in a substantially plume-free operation. Specifically, the simplified air quality control system 100 provides efficient removal of nitrogen oxides, sulfur oxides, and particulates. The simplified air quality control system 100 minimizes the overall footprint as compared to known systems and with reduced overall costs. Specifically, removal of electrostatic precipitators reduces capital expenditures and operating costs while increasing the energy recovery to the grid. Likewise, removal of a gas-gas heater reduces capital costs, improves the overall pressure drop, and eliminates corrosion issues connected with the use of gas-gas heaters in presence of sulfuric gases. A lower pressure drop may allow for an increased energy recovery to the grid. The simplified air quality control system 100 also may require less maintenance with longer catalyst 120 operations.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. An air quality control system for cleaning a flue gas from a fluid catalytic cracking unit, comprising:
a selective catalytic reduction system in communication with the flue gas to remove nitrogen oxides; and
a wet scrubber positioned downstream of the selective catalytic reduction system and in communication with the flue gas to remove sulfur oxides and particulates.

2. The air quality control system of claim 1, further comprising a sulfur trioxide removal system to remove sulfur trioxides.

3. The air quality control system of claim 2, wherein the sulfur trioxide removal system comprises an alkaline dry sorbent or an alkaline solution.

4. The air quality control system of claim 2, wherein the sulfur trioxide removal system comprises a plurality of sorbent injection lances.

5. The air quality control system of claim 4, wherein the plurality of sorbent injection lances is positioned upstream of the selective catalytic reduction system.

6. The air quality control system of claim 1, wherein the selective catalytic reduction system comprises a catalyst for reaction with nitrogen oxides.

7. The air quality control system of claim 6, wherein the selective catalytic reduction system comprises a nitrogen oxide analyzer downstream of the catalyst.

8. The air quality control system of claim 6, wherein the selective catalytic reduction system comprises an injection grid upstream of the catalyst.

9. The air quality control system of claim 8, wherein the selective catalytic reduction system comprises a static mixer upstream of the injection grid.

10. The air quality control system of claim 8, wherein the injection grid comprises a reducing agent.

11. The air quality control system of claim 10, wherein the reducing agent comprises an ammonia or a urea.

12. The air quality control system of claim 1, wherein the wet scrubber comprises a contact vessel with a plurality of spray nozzles and/or perforated plates and a fluid collector.

13. The air quality control system of claim 12, wherein the wet scrubber comprises a recirculation line extending between the fluid collector and the plurality of spray nozzles and/or perforated plates.

14. The air quality control system of claim 1, wherein the wet scrubber comprises an alkaline solution.

15. A method of cleaning a flue gas from a catalytic cracking unit, comprising:
removing nitrogen oxides in the flue gas in a selective catalytic reduction system;
removing sulfur oxides and particulates in the flue gas in a wet scrubber; and
removing sulfur trioxides in the flue gas in a sulfur trioxide removal system if the levels of sulfur trioxide in the flue gas exceed a predetermined level.

16. An air quality control system for cleaning a flue gas from a fluid catalytic cracking unit, comprising:
a selective catalytic reduction system in communication with the flue gas to remove nitrogen oxides;
a wet scrubber positioned downstream of the selective catalytic reduction system and in communication with the flue gas to remove sulfur oxides and particulates; and
a sulfur trioxide oxide removal system in communication with the flue gas to remove sulfur trioxides if the sulfur trioxides exceed a predetermined level.

17. The air quality control system of claim 16, wherein the selective catalytic reduction system comprises an injection grid and a catalyst for reaction with nitrogen oxides.

18. The air quality control system of claim 16, wherein the wet scrubber comprises an alkaline solution sprayed by a plurality of spray nozzles and/or perforated plates into the flue gas.

19. The air quality control system of claim 16, wherein the sulfur trioxide removal system comprises a removal absorbent sprayed by a plurality of injection lances into the flue gas.

20. The air quality control system of claim 19, wherein the plurality of injection lances of the sulfur trioxide removal system is positioned upstream of the selective catalytic reduction system.
